(19) United States
(12) Patent Application Publication
(10) Pub. No.: US 2012/0327096 A1
(43) Pub. Date: Dec. 27, 2012

(54) IMAGE GENERATING DEVICE

(75) Inventor: Mika Minematsu, Kanagawa-ken (JP)

(73) Assignee: KABUSHIKI KAISHA TOSHIBA, Tokyo (JP)

(21) Appl. No.: 13/600,403

(22) Filed: Aug. 31, 2012

Related U.S. Application Data
(63) Continuation of application No. PCT/JP2010/066038, filed on Sep. 16, 2010.

(51) Int. Cl. G09G 5/39

(52) U.S. Cl. 345/531

(57) ABSTRACT

There is provided with an image generating device in which the selecting unit selects a first buffer from frame buffers, the storage stores identification information of a frame buffer storing a latest image on an area-basis, the drawing unit draws and writes image data in the first buffer and specifies an update area including a written area, the updating unit updates the identification information to show that a latest image of the written area is stored i n the first b uffer, the modifying unit specifies an area storing an image that is not the latest in the update area and reads latest image data relating to the area from another frame buffer storing the latest image, and writes it in the area of the first buffer, the image generating unit reads image data of the update area in the first buffer, the communication unit transmits it to the display terminal.

### CROSS REFERENCE TO RELATED APPLICATIONS

This application is a continuation of International Application No. PCT/JP2010/066038, filed on Sep. 16, 2010, the entire contents of which is hereby incorporated by reference.

### FIELD

The present embodiment relates to an image generating device that generates image data displayed on a display terminal connected via a network.

### BACKGROUND

There is a computing system in which a display terminal having a minimal input-output interface is arranged on a user side and complicated operation processing is performed on a remote server device. The server device generates screen information based on input information from the display terminal and transfers it to the display terminal. In such a system, especially when a large screen is treated, a bottleneck of the server device is drawing processing and screen transfer processing. Therefore, by efficiently performing parallel processing of the drawing and transfer, the screen transfer performance improves and usability improves. To perform parallel processing of the drawing and transfer, it is necessary to divide a frame buffer into two frame buffers to use a method called “double buffering.”

In a general double buffering, a drawing buffer and a transfer buffer are prepared as two frame buffers, and, after the drawing of image data is completed in the drawing frame buffer, the drawing data is copied to the transfer frame buffer and transferred from the transfer frame buffer. However, in this method, since the same image data is written in both frame buffers, especially when a large screen is treated, there is a problem that a copy processing load between both frame buffers is large. Further, there is a problem that drawing processing and transfer processing are blocked during a copy.

Meanwhile, there is known a method of performing double buffering for each of partial areas of the screen (i.e., double buffering on area-basis) to suppress the writing count of image data to one. To be more specific, it discloses independently determining a reading frame buffer for each of partial areas of the screen and reading and transferring image data from the determined frame buffer. Meanwhile, the writing of image data is performed for a frame buffer in which the reading is not performed during the reading period. By this means, a copy is, not performed between frame buffers. However, in this image generating device, there is a problem that dedicated hardware is required.

Here, it is considered that a drawing frame buffer and a transfer frame buffer are alternately switched and, at the same time, double buffering is performed on area-basis by software. In this case, image data is written in the drawing frame buffer, and, after the drawing frame buffer and the transfer frame buffer are switched, the written image data is transferred from the transfer frame buffer. In this case, there is no problem as long as only actually-written image data is transferred, but, since a rectangular area is generally treated as a unit for image updating, for example, in a case where a circle is drawn, a background image of an area in which drawing is not actually performed within the rectangular area is transmitted to a display terminal. Accordingly, there may arise a problem that the background image becomes inaccurate (i.e. an older image is displayed). That is, when an image like a circle is written in the rectangular area in a frame buffer (drawing frame buffer) in which an older image remains in the update rectangular area, an image displayed on a display terminal becomes inaccurate.

### BRIEF DESCRIPTION OF THE DRAWINGS

FIG. 1 is a diagram showing an image generating device according to Embodiment 1;

FIG. 2 is a diagram showing examples of a drawing order in which an actual written area is not identical to an update area;

FIG. 3 is a diagram showing an example of the latest FB information;

FIG. 4 is a flowchart for illustrating the flow of image drawing processing in the image generating device according to Embodiment 1;

FIG. 5 is a flowchart for illustrating the flow of image transfer processing in the image generating device according to Embodiment 1;

FIG. 6 is a diagram for illustrating an operation example of double buffering on area-basis according to Embodiment 1;

FIG. 7 is a flowchart for illustrating the flow of image drawing processing in an image generating device according to Embodiment 2;

FIG. 8 is a flowchart for illustrating the flow of image transfer processing in the image generating device according to Embodiment 2; and

FIG. 9 is a diagram for illustrating an operation example of double buffering on area-basis in the related art.

### DETAILED DESCRIPTION

According to an embodiment, there is provided with an image generating device that communicates with a display terminal that displays an image, including: a plurality of frame buffers, a selecting unit, a storage, a drawing unit, an updating unit, a modifying unit, an image generating unit and a communication unit.

The frame buffers each are capable of storing image data of one frame.

The selecting unit selects a first buffer from the frame buffers, the first buffer being a frame buffer in which writing is to be performed.

The storage stores identification information of a frame buffer storing a latest image for each of areas of the one frame.

The drawing unit draws image data according to a drawing order given from an application, writes the image data in the first buffer and specifies an update area including a written area of the image data.

The updating unit updates the identification information in the storage so as to show that a latest image of the written area is stored in the first buffer.

The modifying unit specifies an area storing an image that is not the latest in the update area of the first buffer, reads out latest image data related to the area from another frame buffer of the frame buffers which stores the latest image, and writes the latest image data in the area of the first buffer.

The image generating unit reads all image data of the update area in the first buffer as update image data.

The communication unit transmits the update image data to the display terminal.

In the following, the embodiments will be explained with reference to the figures.

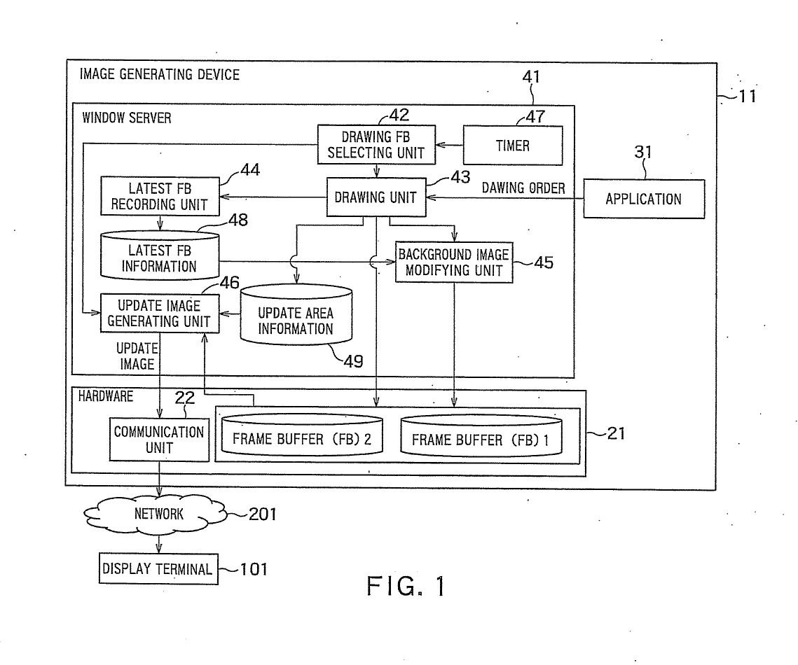

FIG. 1 shows an image generation system having an image generating device according to Embodiment 1. In this image generation system, a display terminal 101 to display image data and an image generating device 11 to generate the image data displayed on the display terminal 101 are connected via a network 201.

The display terminal 101 transmits input information, which is input by a user from a pointing device or an input device such as a keyboard, to the image generating device 11 via the network 201. The display device 101 receives and displays image data generated in the image generating device 11 according to the input information.

The network 201 denotes an arbitrary communication network such as a local area network, wide area network and the Internet.

The image generating device 11 generates the image data displayed on the display terminal 101 (i.e. updates image data), based on the input information received via the network 201 from the display terminal 101, and transfers it to the display terminal 101.

The image generating device 11 has two frame buffers (“FBs”) that can store image data of one frame, and alternately switches and uses these frame buffer 1 and frame buffer 2 as a drawing frame buffer (or writing buffer) and a transfer frame buffer to perform parallel processing of the drawing and transfer of the image data. In Embodiment 1, there is a feature of realizing a new low-load double buffering system without causing failure of a background image in the display terminal.

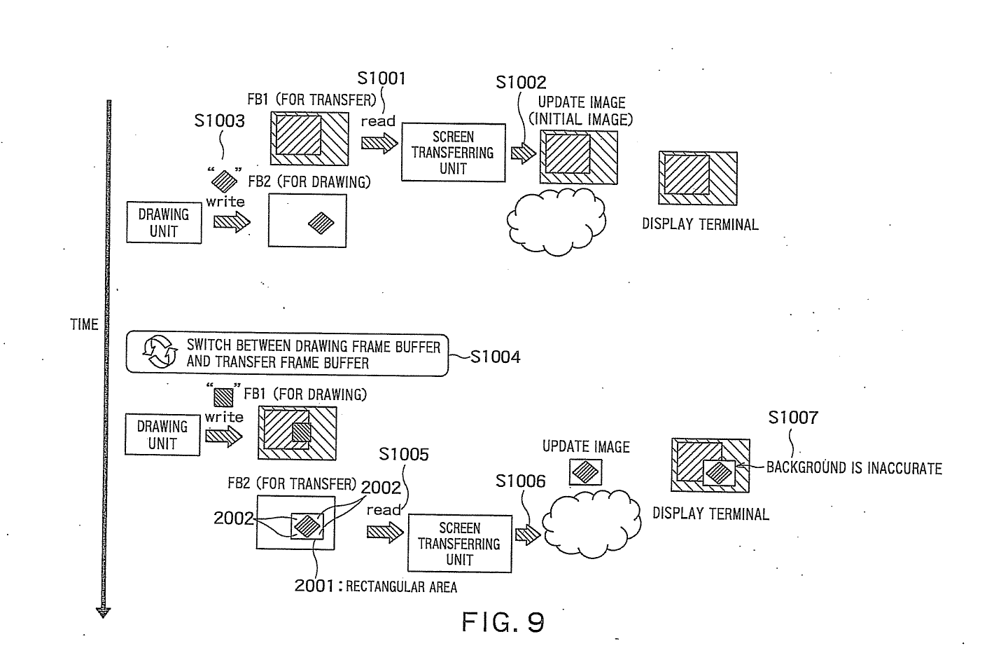

FIG. 9 is a diagram for illustrating a problem in the case of implementing double buffering on area-basis by software in the conventional art.

First, in initial processing, image data of the whole screen of the display terminal is written in the frame buffer 1, and, after the writing is finished, the frame buffer 1 is used as a transfer frame buffer to read and transfer all data in the frame buffer 1 (S1001 and S1002). Input information is received from the display terminal at or after the transfer, and image data is drawn according to the input information and written in the frame buffer 2 (i.e. drawing frame buffer) (S1003). Here, an example is given in which rhombic graphic data is written in an area of the frame buffer 2.

The drawing frame buffer and the transfer frame buffer are switched by a predetermined trigger (S1004) and image data of a drawing area (i.e. update area) is read from the transfer frame buffer and transferred to the display terminal (S1005 and S1006). At this time, generally, the drawing area (or update area) is detected as a rectangular area 2001 including an area of actually written image data (i.e. written area), and image data of the rectangular area is transmitted. Therefore, in spite of the fact that the latest data is present in the frame buffer 1, data 2002 of four outer corner portions of the rhombus in the rectangular area, that is, data that is not the latest in the frame buffer 2 is transferred. Therefore, on the display terminal, an inaccurate image display is performed (S1007). That is, the background image of the rhombus becomes inaccurate.

The embodiment 1 provides a low-load double buffering method that does not cause such an inaccurate background image display.

The image generating device 11 has hardware 21, an application 31 and a window server 41.

The hardware 21 has two frame buffers (FBs) 1 and 2 and a communication unit 22.

The frame buffers 1 and 2 each store image data of one frame. The frame buffers 1 and 2 can be configured with any storage medium used generally such as a RAM (Random Access Memory), HDD (Hard Disk Drive), optical disk and memory card. It should be noted that, although two frame buffers are provided in Embodiment 1, the number of frame buffers provided may be three or more. In this case, two or more frame buffers are simultaneously used as a drawing frame buffer. It should be noted that, although it is omitted in the figure, the hardware 21 includes hardware resources such as a processor and ROM that are generally provided in a computer.

The communication unit 22 receives input information from the display terminal 101 via the network 201 and gives this input information to the application 31. Further, the communication unit 22 transmits update image data generated in an update image generating unit 46 (described later) to the display terminal 101 via the network 201. Part or all of the functions of the communication unit 22 may be realized by a software module (or program). The software module may be stored in a storage medium represented by, for example, a DVD-ROM, CD-ROM, memory device, hard disk drive, and so on.

The application 31 denotes a program of receiving input information from the display terminal 101 via the communication unit 22 (in FIG. 1, a line related to this processing is not shown) and providing various kinds of processing operated on the image generating device 11. In a case where, for example, image data is to be updated in association with executed processing, the application 31 generates a drawing order to request the drawing of image data on the display screen and outputs it to a drawing unit 43 of the window server 41. The drawing order includes information, that is, content of an image to be drawn and information of the coordinate on which the image is requested to be written (i.e. written area). For example, in the case of a 1024×768 pixel screen, the coordinate information denotes information represented by a coordinate system of (0,0) at the upper left of the screen and (1023,767) at the lower right of the screen.

The window server 41 has a drawing FB selecting unit 42, a drawing unit 43, a latest FB recording unit 44, a background image modifying unit 45, an update image generating unit 46 and a timer 47. Although the elements 42 to 47 each are realized as a software module, it is possible to realize part or all of these by hardware. The software modules may be stored in a storage medium represented by, for example, a DVD-ROM, CD-ROM, memory device, hard disk drive, and so on.

The timer 47 outputs an interrupt signal at intervals of a certain time period.

The drawing FB selecting unit 42 selects, from the frame buffers 1 and 2, a drawing frame buffer (writing buffer) that is a frame buffer in which the next writing is performed, according to the interrupt signal from the timer 47. In Embodiment 1, the drawing FB selecting unit 42 alternately selects the frame buffers 1 and 2 as a drawing frame buffer and provides a frame buffer that is not selected, as a transfer frame buffer. That is, by alternately switching the frame buffer 1 and the frame buffer 2, the drawing FB selecting unit 42 switches between the drawing frame buffer and the transfer frame buffer. Further, the drawing FB selecting unit 42 reports identification information of the selected drawing frame buffer to the drawing unit 43. Further, the drawing FB selecting unit 42 instructs the update image generating unit 46 to generate update image data.

The drawing unit 43 receives a drawing order from the application 31 and determines whether a written area is identical to a drawing area (i.e. update area) including the written area, the written area being an area in which the writing is actually performed according to the drawing order. The written area is specified by the coordinate information included in the drawing order. The drawing area (i.e. update area) can be calculated from the coordinate information and a preliminary given method of specifying the drawing area (i.e. update area). As a method of specifying the drawing area (i.e. update area), there is a method of specifying a rectangular area including the written area. For example, in a case where a written image is a filled circle, a rectangular area including this circle is specified as a drawing area (i.e. update area). The rectangular area including the circle may have the minimum size required to include the circle or a larger size than the minimum size. A method of determining the drawing area (i.e. update area) is not limited to the above and it is possible to use an arbitrary method.

In the present embodiment, a type of the drawing order from the application 31 is specified, and, when the drawing order from the application 31 is a predetermined first drawing order, it is determined that the written area and the drawing area (i.e. update area) are not identical to each other or may not be identical to each other. On the other hand, when the drawing order form the application 31 is a second drawing order different from the predetermined first drawing order, it is determined that the written area and the drawing area (i.e. update area) are identical to each other.

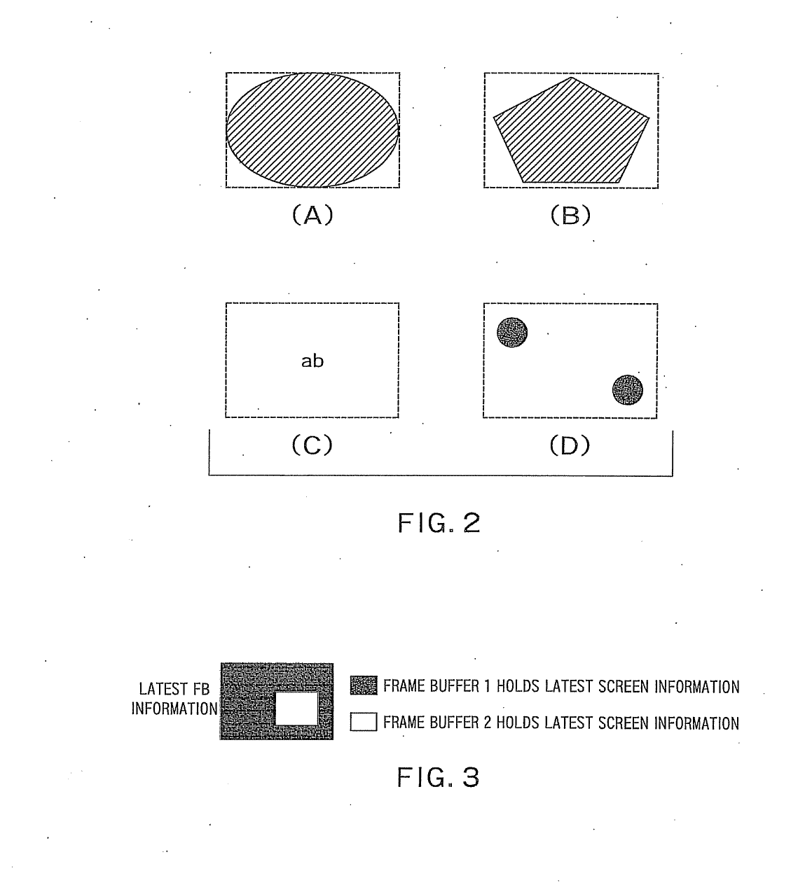

For example, an order to draw a circle, polygon, letters or points as shown in FIGS. 2(A) to 2(D) corresponds to the predetermined first drawing order. In the case of such an order, since the actual written area and the update area (i.e. rectangular area) are not identical to each other, when the conventional double buffering shown in FIG. 9 is used, a case may arise where a background image is not the latest image (i.e. it is an older image). That is, the predetermined first drawing order denotes an order in which the drawing area (i.e. update area) and an area of actually written image data may not be identical to each other (in other words, an order in which a background image can be inaccurate when using the conventional double buffering shown in FIG. 9). Meanwhile, the second drawing order denotes an order in which the drawing area (i.e. update area) and an area of actually written image data are identical to each other (in other words, an order in which a background image cannot be inaccurate even when using the conventional double buffering shown in FIG. 9). For example, in a case where the drawing order denotes a drawing order for a filled image of rectangular and a method of specifying the update area specifies a minimum-size rectangular area including an actually written image, the writing data area and the drawing area (i.e. update area) are identical to each other, so that the background image does not cause failure even when using the conventional double buffering.

When the drawing unit 43 determines that the actual written area and the update area (i.e. rectangular area) may not be identical to each other, that is, in a case where the drawing order form the application 31 matches the predetermined first drawing order, it reports the specified drawing area (i.e. update area) to the background image modifying unit 45. Also, in this case, the drawing unit 43 draws image data subjected to various kinds of image processing based on the drawing order, the drawn image data is subjected to processing in the background image modifying unit 45 which will be described later, and then, the resultant image is written in the corresponding area of the frame buffer (i.e. drawing frame buffer) designated by the drawing FB selecting unit 42.

Also, in a case where the drawing order from the application 31 indicates the second drawing order, the drawing unit 43 determines that processing in the background image modifying unit 45 is omitted. In this case, the drawing unit 43 performs various kinds of image processing according to the drawing order from the application 31, draws image data and writes the image data in the corresponding area of the frame buffer (i.e. drawing frame buffer) designated by the drawing FB selecting unit 42.

In a case where the drawing order from the application 31 indicates the predetermined first drawing order or the second drawing order, the drawing unit 43 reports information of the drawing area (i.e. update area) and identification information of the drawing frame buffer to the latest FB recording unit 44.

Also, in a case where the drawing order from the application 31 indicates the predetermined first drawing order or the second drawing order, the drawing unit 43 records update area information 49 indicating the specified drawing area (i.e. update area) for each drawing frame buffer. The recording destination may be a memory device held in the hardware 21, a storage device such as a hard disk or a storage device externally connected to the image generating device 11. It should be noted that any recording method is possible as long as it is possible to find an update area on the screen. For example, it is possible to record the update area as a list of rectangle information like “rectangular area with 10-pixel width and 10-pixel height from (0,0)” or “rectangular area with 200-pixel width and 5-pixel height from (30,30).”

The latest FB recording unit 44 updates the latest FB information 48 according to the drawing area designated by the drawing unit 43 and the identification information of the drawing frame buffer (the latest FB recording unit performs the updating after processing in the background image modifying unit 45 which is described later). To be more specific, regarding the drawing area designated by the drawing unit 43, the latest FB information 48 is updated so as to show that all latest images in the drawing area are held in the current drawing frame buffer. Here, the latest FB information 48 is configured to hold identification information of a frame buffer holding the latest image for each unit area (e.g. in a pixel unit) of one-frame. An example of the latest FB information 48 is shown in FIG. 3.

The latest FB information 48 is memorized in a memory device held in the hardware 21, a storage device such as a hard disk or a storage device externally connected to the image generating device 11.

The latest FB information 48 can adopt any form as long as each unit area is associated with one frame buffer. For example, the frame buffer 1 may be a list of areas holding the latest image. In this case, regarding an area that is not listed, it is assumed that its latest image is held in the frame buffer 2.

When receiving information of the drawing area (i.e.

update area) specified by the drawing unit 43 in a case where the drawing order from the application 31 indicates the predetermined first drawing order, based on the latest FB information 48 (previously updated), the background image modifying unit 45 specifies an area whose latest image is not held in the current drawing frame buffer, in the drawing area. Then, the latest image of the specified area is read from a frame buffer holding the latest image and written in the corresponding area of the current drawing frame buffer. That is, the latest image of the specified area is copied from the frame buffer holding the latest image to the current drawing frame buffer.

Incidentally, instead of copying the latest image, the background may be made transparent. In this case, on a screen already displayed on the display terminal 101, it is possible to overlap and display only the image data written by the drawing unit 43.

By a trigger from the drawing FB selecting unit 42, the update image generating unit 46 reads all the image data of the update area (i.e. drawing area) from the transfer frame buffer (where, until just before, an image has been drawn as the drawing frame buffer) according to the update area information 49 and generates update image data. The update image generating unit 46 outputs the generated update image data to the communication unit 22 and deletes the update area information 49. The communication unit 22 transmits the update image data from the update image generating unit 46 to the display terminal 101 via the network 201.

In the following, an operation flow of image processing in the image generating device 11 will be explained. The image processing is separated into two processing, i.e., image drawing processing and image transfer processing, the image drawing processing being processing of generating and writing image data in a frame buffer and the image transfer processing being processing of transferring image data of an update area to the display terminal 101.

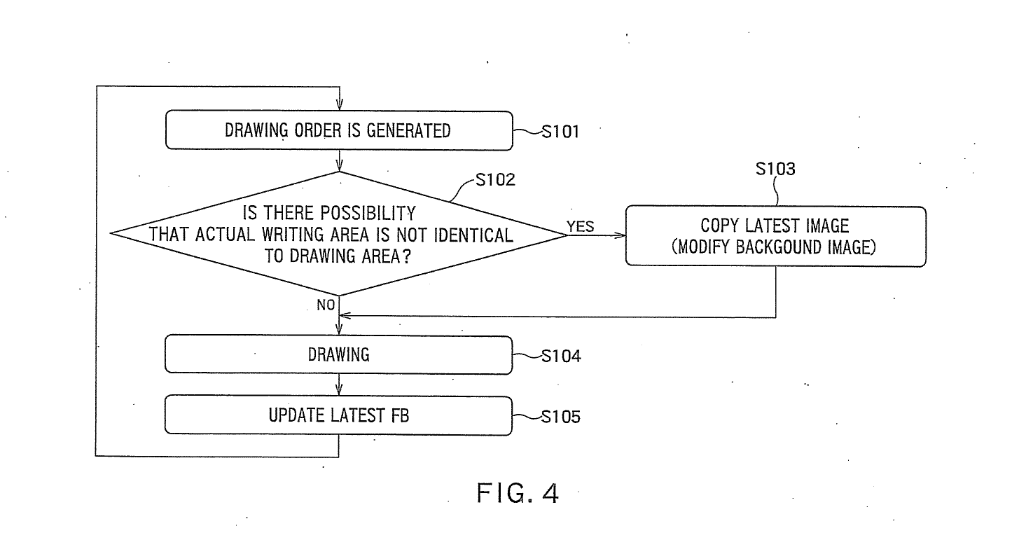

FIG. 4 is a flowchart for illustrating a flow of the image drawing processing in the image generating device 11 according to Embodiment 1.

First, in a case where screen data is updated in association with processing performed according to information input from the display terminal 101, the application 31 outputs a drawing order to request the drawing of the screen (S101).

Next, the drawing unit 43 determines whether the drawing order output from the application 31 is a predetermined first drawing order (i.e. a preliminary designated order made on the assumption that an actual written area and a drawing area may not be identical to each other) (S102).

If the drawing order is the predetermined first order (“YES” in S102), the drawing unit 43 reports the drawing area (i.e. update area) to the background image modifying unit 45. Regarding an area whose latest image is present in another buffer from the current drawing frame buffer in the drawing area, the background image modifying unit 45 copies the latest image of the area from the other frame buffer (S103).

After the copy or when the drawing order is a second drawing order (“NO” in S102), the drawing unit 43 performs image processing according to the drawing order to generate image data and writes the generated image data in an area corresponding to the drawing order in the drawing frame buffer (S104).

Next, the drawing unit 43 reports information of the drawing area and identification information of the drawing frame buffer to the latest FB recording unit 44 and the latest FB recording unit 44 updates the latest FB information 48 so as to show that all latest images about the reported drawing area are held in the drawing frame buffer (S105).

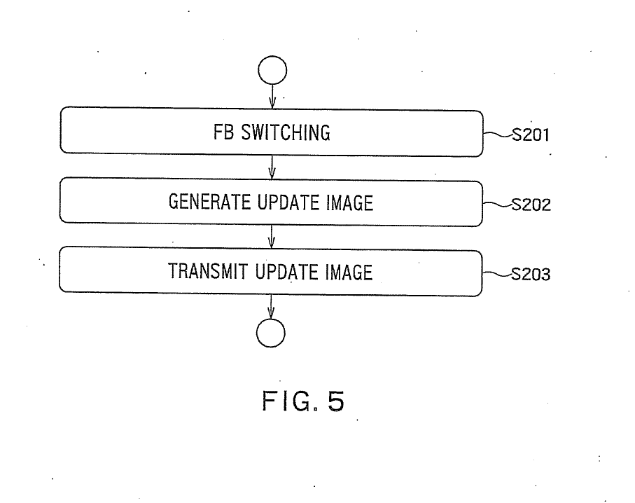

FIG. 5 is a flowchart for illustrating a flow of the image transfer processing in the image generating device 11 according to Embodiment 1. The image transfer processing starts by, for example, regular interrupts from the timer 47. However, the trigger needs not be a timer. For example, a threshold is set for a number of times of drawing (i.e., drawing count) and it starts at intervals of the drawing count.

First, the drawing FB selecting unit 42 performs switching processing between the drawing frame buffer and the transfer frame buffer (S201).

Next, according to the update area information 49, the update image generating unit 46 reads image data of an update area from the transfer frame buffer and generates update image data (S202).

Next, the communication unit 22 transmits the update image data to the display terminal 101 (S203).

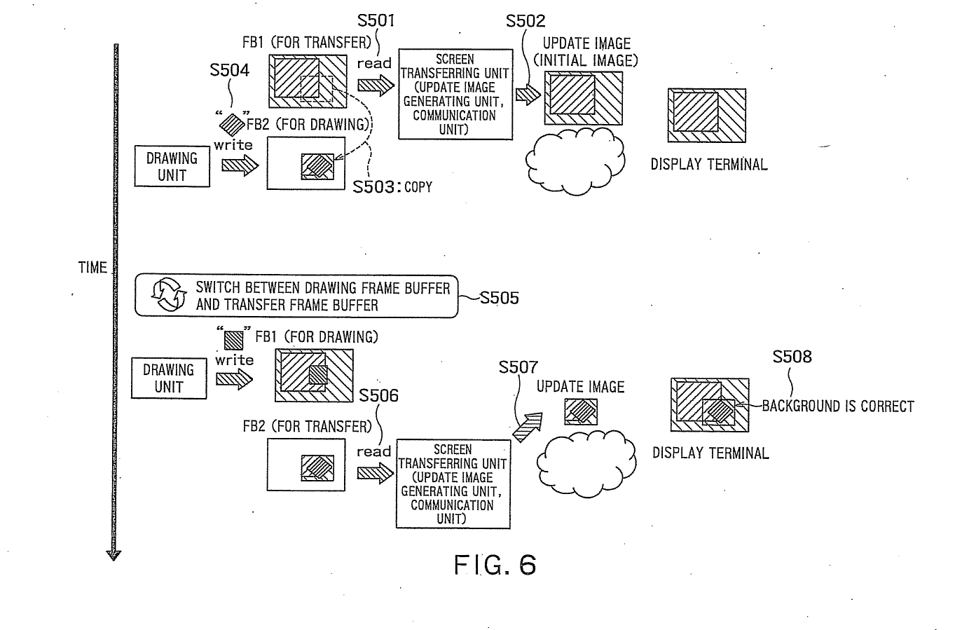

FIG. 6 is a diagram for specifically illustrating that it is possible to perform image transfer by double buffering per area according to Embodiment 1, without causing failure.

First, in the initial processing, image data of the entire screen of the display terminal 101 is written in one frame buffer 1, and, after the writing is finished, the frame buffer 1 is used as a transfer frame buffer to read and transfer all the data in the frame buffer 1 (S501 and S502). Input information is received from the display terminal 101 at or after the transfer, and an image order is issued by the application 31 according to the input information. As a drawing order, the drawing of rhombic graphic data is instructed. The drawing unit 43 determines that this order matches a predetermined first drawing order, and the background modifying unit 45 copies the latest image of an area whose latest image is not present in the drawing frame buffer (i.e. frame buffer 2) in the drawing area (i.e. update area) including an actual written area, from the other frame buffer (i.e. frame buffer 1) to the frame buffer 2 (here, it should be noted that, since all latest images of the drawing area are present in the frame buffer 1, all image data of the drawing area is copied from the frame buffer 1 to the frame buffer 2) (S503). The drawing unit 42 draws rhombic image data according to the drawing order and, after the copy in step S503, writes the rhombic image data in the frame buffer 2 (i.e. drawing frame buffer) (S504).

After that, the drawing frame buffer and the transfer frame buffer are switched by a predetermined trigger (such as an output from the timer) (S505) and all image data of the drawing area (i.e. update area) is read by the update image generating unit 46 from the transfer frame buffer and transferred to the display terminal 101 (S506 and S507). The background image of the drawing area (i.e. update area) is the latest image, so that failure of the background image is not caused in the display terminal 101 and a correct image display is performed (S508).

In Embodiment 1 described above, in the update of the latest FB information 48, the latest FB information 48 is updated so as to show that the latest image of a whole of the drawing area specified by the drawing unit 43 is held in the drawing frame buffer. However, it may be possible to update it so as to show that, for only an actual written area by the drawing unit 43, the latest image is held in the drawing frame buffer. In this case, in the operation flow in FIG. 4, step S105 for updating may be performed before step S103 for copying the latest image. In the former case (i.e. in the case of updating all the drawing area), it is not necessary to calculate an actual written area, so that there is an advantage of being able to simplifying processing. What is described in this paragraph is equally applicable to Embodiment 2 described below.

In view of the above, according to Embodiment 1, a background image of a drawing area (i.e. update area) including an actual written area is made the latest, and after that, actual image data is written in a drawing frame buffer. Therefore, it is possible to prevent failure of the background image in a display terminal when performing double buffering on area-basis b y software.

Also, Embodiment 1 does not require dedicated hardware compared to the method disclosed in the background and therefore provides an advantage of high versatility.

Also, in Embodiment 1, only the latest image is required to be copied and this copy can be performed only when a drawing order matches a predetermined first drawing order, so that a copy processing load is lower than the general double buffering described in the background

Also, in Embodiment 1, a block period of the drawing and transfer processing is shorter than the general double buffering described in the background (Le. although image drawing processing for the drawing frame buffer shown in FIG. 4 and image transfer processing from the transfer frame buffer shown in FIG. 5 are performed in parallel, a period of blocking (or preventing) the drawing processing and the transfer processing is only a time period required to switch between the drawing frame buffer and the transfer frame buffer).

Thus, according to Embodiment 1, it is possible to realize efficient parallel processing of drawing and transfer without causing image failure and with a lower load.

### Embodiment 2

In above Embodiment 1, although the latest image is copied between frame buffers before the drawing by the drawing unit 43, a case will be described in Embodiment 2 where the latest image is copied after the drawing. The block diagram for Embodiment 2 is the same as Embodiment 1. Only differences from Embodiment 1 will be explained below.

In a case where a predetermined first drawing order is detected in the drawing unit 43, the background image modifying unit 45 treats a drawing area (i.e. update area) reported from the drawing unit 43, as a background modification area, and holds information of the background modification area.

The background image modifying unit 45: specifies a part (i.e. area) in which the drawing unit 43 does not actually perform writing in the background modification area; finds, from the latest FB information, an area whose latest image is not held in a drawing frame buffer in the specified area; reads image data of the area from the other frame buffer holding the latest image; and writes it in the drawing frame buffer. By this means, the background image in the area in which drawing is not actually performed, is made the latest (i.e. corrected). When the writing is completed, the background image modifying unit 45 deletes information of the background modification area.

Here, regarding a method of detecting the part in which the drawing is not actually performed in the background modification area, for example, it is equally possible to store image data of the background modification area in the drawing frame buffer before the drawing by the drawing unit 43, compare it with image data after the drawing and detect a part without changes. It should be noted that, similar to above Embodiment 1, the background may be made transparent instead of copying the latest image (i.e. correct background image). In this case, by displaying it so as to overlap the latest image (i.e. correct background) already displayed on the display terminal 101, it is possible to display a correct image.

In the following, flows of image drawing processing and image transfer processing of an image generating device according to Embodiment 2 will be explained.

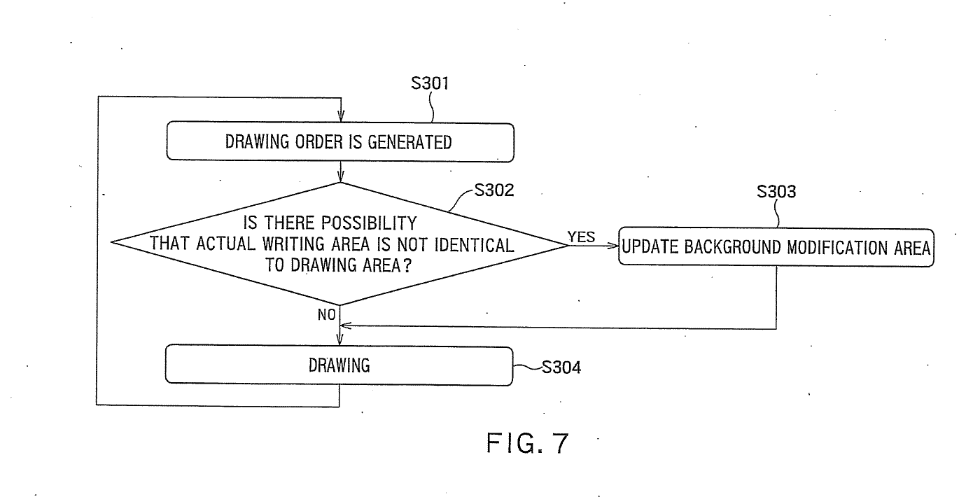

FIG. 7 is a flowchart for explaining image drawing processing according to Embodiment 2.

When a drawing order is output from the application 31 (S301), the drawing unit 43 determines whether the drawing order matches a drawing order designated in advance (S302).

In a case where the drawing order from the application 31 matches the predetermined first drawing order (“YES” in S302), the drawing unit 43 reports a drawing area (i.e. update area) to the background image modifying unit 45 and the background image modifying unit 45 records it as a background modification area (S303). Also, in this case, the background image modifying unit 45 temporarily records all image data of the background modification area in the drawing frame buffer.

The drawing unit 43 performs image processing according to the drawing order to generate image data and writes the generated image data in the drawing frame buffer according to coordinate information included in the drawing order (S304).

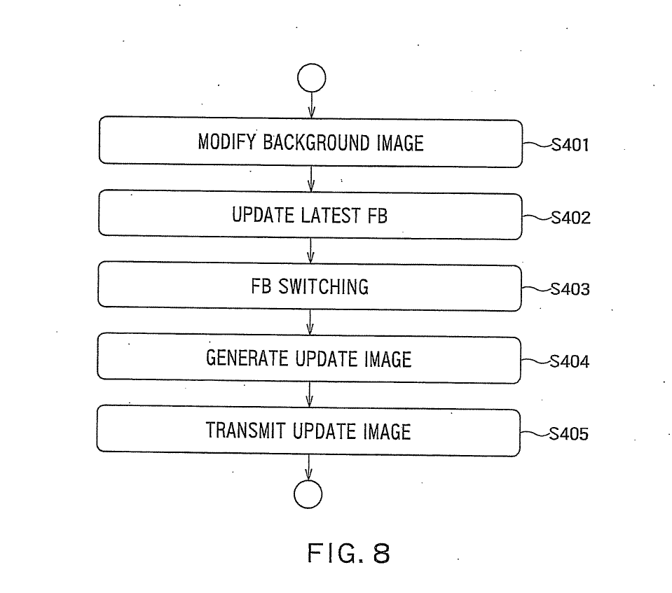

FIG. 8 is a flowchart for illustrating a flow of image transfer processing according to Embodiment 2.

Before processing of switching between the drawing frame buffer and the transfer frame buffer, the background image modifying unit 45 compares image data of the background modification area recorded in step S303 of FIG. 7 and image data of the background modification area after the drawing by the drawing unit 43, and specifies an area in which the writing is not actually performed (S401). Then, an area whose latest image is not held in the drawing frame buffer in the specified area is specified by the latest FB information 48, a frame buffer holding the latest image of the specified area is found from the latest FB information 48, and the image data of the specified area is read from the found frame buffer and copied in the drawing frame buffer (S401).

Next, in the same way as in above Embodiment 1, the latest FB recording unit 44 updates the latest FB information 48 (S402).

Subsequent steps S403 to S405 are similar to S201 to S203 in FIG. 5 in above Embodiment 1, and therefore an overlapping explanation will be omitted.

In view of the above, according to Embodiment 2, at the time of transfer to a display terminal, a background image of an area different from an actual written area in a drawing area is made the latest and transferred, so that, in the case of performing double buffering on area-basis by software, it is possible to prevent failure of a background image in a display terminal. Further, according to Embodiment 2, since an area different from an actual written area in an update area is processed as a target of copy processing, there is a high possibility that a required copy amount of the latest image becomes less than that of Embodiment 1, so that it is expected to suppress processing time and processing load to less than those of Embodiment 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image generating device that communicates with a display terminal that displays an image, comprising:
a plurality of frame buffers each being capable of storing image data of one frame;
a selecting unit configured to select a first buffer from the frame buffers, the first buffer being a frame buffer in which writing is to be performed;
a storage configured to store identification information of a frame buffer storing a latest image for each of areas of the one frame;
a drawing unit configured to draw image data according to a drawing order given from an application, write the image data in the first buffer and specify an update area including a written area of the image data;
an updating unit configured to update the identification information in the storage so as to show that a latest image of the written area is stored in the first buffer;
a modifying unit configured to specify an area storing an image that is not the latest in the update area of the first buffer, read out latest image data related to the area from another frame buffer of the frame buffers which stores the latest image, and write the latest image data in the area of the first buffer;
an image generating unit configured to read all image data in the update area in the first buffer as update image data; and
a communication unit configured to transmit the update image data to the display terminal.

2. The device according to claim 1, wherein the drawing unit checks whether the written area and the update area are identical to each other, and if so, processing by the modifying unit is omitted.

3. The device according to claim 2, wherein the drawing unit specifies a type of the drawing order, determines that the written area and the update area are not identical to each other when the drawing order is a first drawing order, and determines that the written area and the update area are identical to each other when the drawing order is a second drawing order different from the first drawing order.

4. The device according to claim 1, wherein:
processing is performed in order from the modifying unit to the drawing unit and then to the updating unit; and
the updating unit updates the storage so as to show that all images in the update area in the first buffer are latest.

5. The device according to claim 1, wherein the modifying unit specifies an area storing an image that is not the latest, in a remaining area obtained by the written area being excluded from the update area, and reads out latest image data related to the area, from said other frame buffer.
